(19) United States
(12) Patent Application Publication
(10) Pub. No.: US 2025/0112325 A1
(43) Pub. Date: Apr. 3, 2025

(54) BATTERY SYSTEM WITH IMPROVED THERMAL RUNAWAY HANDLING

(71) Applicant: SAMSUNG SDI CO., LTD., Yongin-si (KR)

(72) Inventors: Balazs SUBA, Graz (AT); Gernot KRABERGER, Graz (AT); Nikolaus HOCHGATTERER, Graz (AT)

(21) Appl. No.: 18/663,902

(22) Filed: May 14, 2024

(30) Foreign Application Priority Data
Sep. 28, 2023 (EP) 23200304.6

(51) Int. Cl. H01M 50/367; H01M 10/658; H01M 50/224; H01M 50/24; H01M 50/249; H01M 50/375

(52) U.S. Cl. CPC H01M 50/367; H01M 10/658; H01M 50/224; H01M 50/24; H01M 50/249; H01M 50/375; H01M 2220/20

(57) ABSTRACT

A battery system includes: a housing; a battery cell accommodated within the housing, the battery cell having a venting side with a venting exit; and a housing cover sealing the battery cell in the housing. The housing cover includes an outer layer and an inner layer, the inner layer facing the venting side and forming part of a venting channel, and the outer layer being coated on its outside surface with an anti-corrosion coating. The outer layer and the inner layer are spaced from each other such that an air gap is formed between the outer layer and the inner layer.

### CROSS-REFERENCE TO RELATED APPLICATION

The present application claims priority to and the benefit of European Patent Application No. 23200304.6, filed on Sep. 28, 2023, in the European Union Intellectual Property Office, the entire disclosure of which is incorporated herein by reference.

### BACKGROUND

### 1. Field

Aspects of embodiments of the present disclosure relate to a battery system with improved thermal runaway handling.

### 2. Description of the Related Art

Recently, vehicles for transportation of goods and people have been developed that use electric power as a source for motion. Such an electric vehicle is an automobile that is propelled by an electric motor, using energy stored in rechargeable batteries. An electric vehicle may be powered solely by batteries or may be a hybrid vehicle powered by, for example, a gasoline generator or a hydrogen fuel cell. A hybrid vehicle may include a combination of an electric motor and conventional combustion engine. Generally, an electric-vehicle battery (EVB or traction battery) is a battery used to power the propulsion of battery electric vehicles (BEVs). Electric-vehicle batteries differ from starting, lighting, and ignition batteries in that they are designed to provide power over sustained periods of time. A rechargeable (or secondary) battery differs from a primary (or non-rechargeable) battery in that it is designed to be repeatedly charged and discharged, while the latter is designed to provide only an irreversible conversion of chemical to electrical energy. Low-capacity rechargeable batteries are used as power supplies for small electronic devices, such as cellular phones, notebook computers, and camcorders, while high-capacity rechargeable batteries are used as power supplies for electric and hybrid vehicles and the like.

Generally, rechargeable batteries include an electrode assembly including a positive electrode, a negative electrode, and a separator interposed between the positive and negative electrodes, a case accommodating the electrode assembly, and an electrode terminal electrically connected to the electrode assembly. An electrolyte solution is injected into the case to enable charging and discharging of the battery via an electrochemical reaction between the positive electrode, the negative electrode, and the electrolyte solution. The shape of the case, such as a cylindrical or rectangular shape, may be selected based on the battery's intended purpose. Lithium-ion (and similar lithium polymer) batteries, widely known via their use in laptops and consumer electronics, are the dominant form of secondary batteries used in the most recent electric vehicles in development.

Rechargeable batteries may be used as a battery module including a plurality of unit battery cells coupled to each other in series and/or in parallel to provide high power density, such as for motor driving of a hybrid vehicle. For example, the battery module may be formed by interconnecting the electrode terminals of the plurality of unit battery cells in an arrangement or configuration depending on a desired amount of power and to provide a high-power rechargeable battery.

Battery modules can be constructed in either a block design or in a modular design. In the block design, each battery is coupled to a common current collector structure and a common battery management system, and the unit thereof is arranged in a housing. In the modular design, pluralities of battery cells are connected together to form submodules, and several submodules are connected together to form the battery module. In automotive applications, battery systems generally include a plurality of battery modules connected together in series to provide a desired voltage. The battery modules may include submodules including a plurality of stacked battery cells (e.g., a battery stack or stack), and each stack includes cells connected together in parallel that are, in turn, connected in series (XpYs) or cells connected together in series that are, in turn, connected in parallel (XsYp).

A battery pack is a set of any number of (usually identical) battery modules. The battery modules may be connected in series, parallel, or in a series/parallel connection configuration to provide a desired voltage, capacity, and/or power density. Components of a battery pack include the individual battery modules and the interconnects, which provide electrical conductivity between the battery modules.

To provide thermal control of the battery pack, a thermal management system is desirable to safely use the at least one battery module by efficiently emitting, discharging, and/or dissipating heat generated from its rechargeable batteries. If the heat emission, discharge, and/or dissipation is not sufficiently performed, temperature differences between respective battery cells may occur, such that the at least one battery module may no longer generate a desired (or designed) amount of power. In addition, an increase of the internal temperature can lead to abnormal reactions occurring therein. Thus, charging and discharging performance of the rechargeable battery may deteriorate, and the lifespan of the rechargeable battery may be shortened. Thus, cell cooling to effectively dissipate heat from the battery cells is desirable.

Exothermic decomposition of cell components may lead to a so-called thermal runaway. Generally, thermal runaway describes or refers to a process that accelerates due to increased temperature, in turn releasing energy that further increases temperature. Thermal runaway occurs in situations when an increase in temperature changes the conditions in a way that causes a further increase in temperature, often leading to a destructive result. In rechargeable battery systems, thermal runaway is associated with strong exothermic reactions that are accelerated by temperature rise. These exothermic reactions include combustion of flammable gas compositions within the housing. For example, when a cell is heated above a critical temperature (for example, above about 150° C.) the cell can transition into a thermal runaway. The initial heating may be caused by a local failure, such as a cell internal short circuit, heating from a defective electrical contact, short circuiting to a neighboring cell, etc. During the thermal runaway, a failed battery cell, (e.g., a battery cell that has or is experiencing a local failure) may reach a temperature exceeding about 700° C. Further, large quantities of hot gas are ejected from inside of the failed battery cell through a venting opening in a cell housing into the battery pack. The main components of the vented gas are H₂, CO₂, CO, electrolyte vapor, and other hydrocarbons. The vented gas is, therefore, flammable and potentially toxic. The vented gas also causes a gas-pressure to increase inside the battery pack.

One comparative venting concept for a battery is to let the hot venting gas stream of a battery cell in a thermal runaway condition exit the battery cell(s), expand into the housing, and escape through a housing venting valve to the outside (e.g., the environment of the housing). The venting gas stream thereby heats up the housing, for example, parts of the housing opposite the venting exits of the battery cells (e.g., a housing cover). This may compromise an anti-corrosion coating applied to an outside surface of the housing cover and, thus, may expose the housing cover to corrosion.

### SUMMARY

Aspects of some embodiments of the present disclosure provide a battery system that more securely handles a thermal runaway of one or more of its battery cells without damaging components of the battery system.

The present disclosure is defined by the appended claims and their equivalents. Any disclosure lying outside the scope of the claims is intended for illustrative as well as comparative purposes.

According to an embodiment of the present disclosure, a battery system includes: a housing; a battery cell accommodated within the housing, the battery cell having a venting side with a venting exit; and a housing cover sealing the battery cell in the housing. The housing cover includes an outer layer and an inner layer, the inner layer facing the venting side and forming part of a venting channel, and the outer layer being coated on its outside surface with an anti-corrosion coating. The outer layer and the inner layer are spaced from each other such that an air gap is formed between the outer layer and the inner layer.

In some embodiments, the inner layer may be a plate attached to an inside surface of the outer layer.

In some embodiments, the air gap may extend along a first length, the venting side may extend along a second length, and the first length may be smaller than the second length.

In some embodiments, the anti-corrosion coating may be a zinc-nickel coating.

In some embodiments, both the outer layer and the inner layer may include steel or a steel alloy.

In some embodiments, the inner layer may include a guide projection protrusion protruding from the inner layer into the venting channel and towards the venting exit to guide the venting gas stream exhausted through the venting exit into the venting channel.

In some embodiments, the guide projection may be a gas splitting projection having a tapered shape with a tip facing the venting exit and may be configured to separate the venting gas stream such that the venting gas stream is deflected to opposite sides of the venting channel.

In some embodiments, the battery system may further include a plurality of the battery cells arranged inside the housing. The housing cover may include a plurality of steel plates attached to an inside surface of the outer layer of the housing cover, and each of the steel plates may face the venting side of a respective one of the battery cells. An air gap may be formed as a free space confined between each of the steel plates and the outer layer of the housing cover.

According to some embodiments of the present disclosure, an electric vehicle includes the battery system as described above.

Further aspects and features of the present disclosure can be learned from the dependent claims or the following description.

### BRIEF DESCRIPTION OF THE DRAWINGS

Aspects and features of the present disclosure will become apparent to those of ordinary skill in the art by describing, in detail, embodiments thereof with reference to the attached drawings, in which:

FIG. 1 is a cross-sectional view of a battery system according to an embodiment of the present disclosure.

FIG. 2 is a perspective view of a housing cover shown in FIG. 1.

FIG. 3 is a cross-sectional view of a battery system according to another embodiment of the present disclosure.

### DETAILED DESCRIPTION

Reference will now be made, in detail, to embodiments, examples of which are illustrated in the accompanying drawings. Aspects and features of the embodiments, and implementation methods thereof, will be described with reference to the accompanying drawings. The present disclosure, however, may be embodied in various different suitable forms and should not be construed as being limited to the embodiments described herein. Rather, these embodiments are provided as examples so that this disclosure will be thorough and complete and will fully convey the aspects and features of the present disclosure to those skilled in the art.

Accordingly, processes, elements, and techniques that are not considered necessary to those having ordinary skill in the art for a complete understanding of the aspects and features of the present disclosure may not be described. In the drawings, the relative sizes of elements, layers, and regions may be exaggerated for clarity.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

As used herein, the term “and/or” includes any and all combinations of one or more of the associated listed items. The same reference numerals designate the same elements. Further, the use of “may” when describing embodiments of the present disclosure refers to “one or more embodiments of the present disclosure.” In the following description of embodiments of the present disclosure, the terms of a singular form may include plural forms unless the context clearly indicates otherwise.

It will be understood that although terms such as “first” and “second” are used to describe various suitable elements, these elements should not be limited by these terms. These terms are only used to distinguish one element from another element. For example, a first element may be named a second element and, similarly, a second element may be named a first element, without departing from the scope of the present disclosure. As used herein, the term “and/or” includes any and all combinations of one or more of the associated listed items. Expressions such as “at least one of,” when preceding a list of elements, modify the entire list of elements and do not modify the individual elements of the list. For example, the expression “at least one of a, b, or c” indicates only a, only b, only c, both a and b, both a and c, both b and c, all of a, b, and c, or variations thereof. As used herein, the terms “use,” “using,” and “used” may be considered synonymous with the terms “utilize,” “utilizing,” and “utilized,” respectively.

As used herein, the term “substantially,” “about,” and similar terms are used as terms of approximation and not as terms of degree and are intended to account for the inherent deviations in measured or calculated values that would be recognized by those of ordinary skill in the art. Further, if the term “substantially” is used in combination with a feature that could be expressed using a numeric value, the term “substantially” denotes a range of +/−5% of the value centered on the value.

It will be further understood that the terms “include,” “comprise,” “including,” or “comprising” specify a property, a region, a fixed number, a step, a process, an element, a component, and a combination thereof but do not exclude other properties, regions, fixed numbers, steps, processes, elements, components, and combinations thereof.

It will also be understood that when a film, a region, or an element is referred to as being “above” or “on” another film, region, or element, it can be directly on the other film, region, or element, or intervening films, regions, or elements may also be present.

Herein, the terms “upper” and “lower” are defined according to the z-axis. For example, the upper cover is positioned at the upper part of the z-axis, and the lower cover is positioned at the lower part thereof. In the drawings, the sizes of elements may be exaggerated for clarity. For example, in the drawings, the size or thickness of each element may be arbitrarily shown for illustrative purposes, and thus, the embodiments of the present disclosure should not be construed as being limited thereto.

In the following description of embodiments of the present disclosure, the terms of a singular form may include plural forms unless the context clearly indicates otherwise.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

According to an embodiment of the present disclosure, a battery system includes a housing and at least one battery cell accommodated within the housing. The battery system may include a plurality of battery cells accommodated within the housing, and the battery cells form a battery pack. The battery cells may be interconnected via busbars contacting the respective electrode terminals of the battery cells to form one or more battery modules. The battery cells may be, for example, prismatic or cylindrical cells. The battery cells may include venting exits at a venting side of the battery cells, which is, for example, the terminal side of the battery cells. The venting exits allow a venting gas stream to escape the battery cells during a thermal runaway. Venting valves may be provided at (or in) the venting exits. A cover plate may cover the venting side, and the cover plate may have a through-hole arranged at (e.g., aligned with) the venting exit for letting the venting gas stream pass through the through-hole.

The battery system may further include a housing cover. The housing cover may be considered part of the housing. The housing cover may be a cover plate, for example, an upper cover plate arranged at an upper side/top side of the battery system or a lower cover plate arranged at a lower side/bottom side of the battery system. The housing cover may be attached to a base of the housing after the battery cells have been inserted into the housing base. The housing cover seals (e.g., closes) the housing to the outside (e.g., the environment of the battery system). The housing cover, in combination with the other parts of the housing, such as the housing base, may seal the inside of the housing from the outside of the housing such that a venting gas stream exhausted by one or more battery cells during a thermal runaway may escape the housing and, thus, the battery system, only at passages or openings provided for this purpose (e.g., at a venting valve arranged in a housing wall of the housing). The housing cover may seal the battery pack from the outside in an airtight manner.

The housing cover may include an outer layer and an inner layer. The inner layer and/or the outer layer may be made of steel. The outer layer may delimit the housing cover to the outside of the housing, and the inner layer may delimit the housing cover to the inside of the housing. For example, the inner layer of the housing cover faces towards the inside of the housing. For example, the inner layer may face the venting side of the battery cell. The inner layer may be arranged opposite a venting exit of the battery cell such that a venting gas stream exiting the venting exit of the battery cell flows against the inner layer and is deflected by the inner layer to the sides of the housing. The venting gas stream thus flows along a venting channel, which is formed at least in part by the inner layer. The inner layer may delimit the venting channel to one side. The venting channel may be delimited at the opposite side by the venting side of the battery cell or by the above-mentioned cover plate, if present. Thus, the venting channel may be formed by the inner layer and the venting side/cover plate. The venting gas stream exhausted through the venting exit into the venting channel during a thermal runaway may be deflected by the inner layer and guided along the venting channel away from the venting exit. As the venting gas stream flows from the venting exit towards and against the inner layer of the housing cover, heat is transferred from the venting gas stream to the inner layer, thus cooling the venting gas stream.

The outer layer of the housing cover may be coated on its outside surface with an anti-corrosion coating. The outside surface is the surface of the outer layer facing to the outside (e.g., the environment of the housing/battery system) and, thus, away from the inner layer of the housing cover. The anti-corrosion coating prevents or reduces corrosion of the outer layer and, thus, of the housing cover from outside sources. The anti-corrosion coating protects the housing cover from damage from moisture that may come into contact with the housing cover from the outside of the housing/battery system. Such an anti-corrosion coating may be damaged if exposed to high temperatures, as mentioned above. For example, if the outer layer of the housing cover comes into contact with the venting gas stream, the outer layer might heat up so much that the anti-corrosion coating may be compromised. This may result in the housing cover becoming corroded, which may in turn cause the internal components of the battery system to become damaged due to moisture entering the housing and/or to leakage of, for example, venting gases to the outside.

Therefore, according to embodiments of the present disclosure, the inner layer is provided to protect the outer layer from the venting gas stream. An air gap is formed between the outer layer and the inner layer. The inner layer and the outer layer are distanced (e.g., spaced) from each other such that the air gap is formed as a free space (e.g., an open space or void) confined between the inner layer and the outer layer. For example, a free space is confined between the reflection plate and the housing cover, and the free space is filled with air. The air gap may be located at least at a part of the housing cover that is arranged opposite the venting exit. The housing cover, according to embodiment of the present disclosure, may include a double-layer structure with the air gap in between.

When the venting gas stream exiting the venting exit of the battery cell flows against the inner layer and transfers heat to the inner layer, the air gap on the other side of the inner layer acts as thermal insulation, hindering heat transfer from the inner layer to the outer layer of the housing cover. This prevents or reduces excessive heating of the outer layer of the housing cover and, thus, prevents or reduces damage to the anti-corrosion coating of the outer layer. This improves (e.g., increases) the life expectancy of the coating and, thus, of the battery system.

According to an embodiment, the inner layer may be formed by a plate attached to the inside surface of the outer layer of the housing cover. The inside surface of the outer layer is the surface of the outer layer facing the inside of the housing. The plate is distanced from the outer layer to form the air gap in between the plate and the outer layer, as explained above. The plate may be a steel plate. The plate may be welded to the inside surface of the outer layer of the housing cover. When the battery system includes a plurality of battery cells, such a plate may be provided for each of the battery cells. For example, for every battery cell, such a plate may be attached to the inside surface of the outer layer of the housing cover, with each plate respectively facing the venting side opposite the venting exit of one of the battery cells. Such a plate allows for relatively simple construction of the inner layer and the air gap and, thus, of the double-layer structure. Such a plate may be attached to existing housing covers that are generally available. Such a plate may be used with known battery systems.

According to an embodiment, the air gap extends along a first length, the venting side extends along a second length, and the first length is smaller than the second length. Extending along the length, as used herein, means extending along a same direction or axis. Extending along the length may mean, for example, extending along a longitudinal axis of the battery cell. The length may be a direction or axis along which the venting gas primarily streams. For example, the inner layer may extend not along the complete (or entire) length of the venting side of the battery cell but along only a part of the venting side/battery cells. For example, the inner layer may only partially cover the venting side/battery cell in the area opposite of the venting exit. The venting gas stream may, after having been deflected by the inner layer as explained above, contact the inner surface of the outer layer. The first length is determined or designed such that the venting gas stream has sufficient time to transfer heat to the inner layer and, thus, to sufficiently cool the venting gas stream so as to not damage the outer layer and the coating thereon when coming into contact with the outer layer. Thus, the inner surface of the outer layer may be exposed to the venting gas at a distance sufficiently far from the venting exit so that the venting gas stream has cooled enough not to damage to the coating on the outer layer. The inner layer is formed by the plate, in one embodiment. According to an embodiment, the air gap may contact less than the entire inner surface. In such an embodiment, construction of the air gap may be simpler than providing an air gap along the entire inner surface of the outer layer.

According to an embodiment, the anti-corrosion coating may be a zinc-nickel coating. Such a coating is well-suited to prevent or reduce corrosion of the outer layer of the housing cover but is sensitive to temperature. Due to the double-layer structure of the housing cover with the air gap between the inner layer and the outer layer, thermal damage to the anti-corrosion coating from the venting gas stream may be prevented or at least significantly reduced.

According to an embodiment, both the outer layer and the inner layer may be made of steel or a steel alloy. Both the outer layer and the inner layer may be made of the same or substantially the same steel or steel alloy. The layers may both be made of, and/or may consist of, or mainly include steel or steel alloy. This allows for the housing cover to be suitably rigid and/or suitably resilient.

According to an embodiment, the inner layer includes a guide projection formed as a protrusion in the inner layer and projecting towards the venting exit into the venting channel for guiding the venting gas stream exhausted through the venting exit and into the venting channel. According to an embodiment, the guide projection may be a gas splitting projection having a tapered shape with a tip facing the venting exit and configured to split (or separate) the venting gas stream such that the venting gas stream is deflected to opposite sides of the venting channel. Thus, in such an embodiment, the inner layer of the housing cover may include a guide projection, for example, a projecting element for guiding the venting gas stream. The guide projection may be an integrated (or integral) guide projection; for example, the guide projection may be an integral part of the inner layer of the housing cover. For example, the inner layer may form the guide projection. For example, the guide projection may be a protrusion in (or protruding from) the inner layer. The guide projection projects towards the venting exit of the at least one battery cell and, thus, projects into the venting channel. The guide projection is configured to guide the venting gas stream exhausted through the venting exit of the battery cell during a thermal runaway event away from the venting exit. The guide projection is configured to split the venting gas stream in two sub-streams and to direct these sub-streams in opposite directions away from one another. The guide projection leads (or directs) the venting gas stream away from the venting exit and from the battery cell along the venting channel. This allows for the venting gas stream to be transported away quickly and reliably. Also, the guide projection may enlarge the surface area of the inner layer so that the venting gas stream may transfer heat suitably well to the inner layer to sufficiently cool the venting gas stream. The guide projection may also reduce the pressure drop during exhausting of the venting gas stream by using an aerodynamically efficient design. The guide projection may act as a collector for molten particles, which are carried with the venting gas stream. The inner layer and, thus, also the guide projection may be formed by the above-mentioned (e.g., steel) plate as to simplify construction.

According to an embodiment, the battery system includes a plurality of battery cells arranged inside the housing, and the housing cover includes a plurality of plates attached to the inside surface of the outer layer of the housing cover. Each of the plates faces the venting side opposite the venting exit of one of the battery cells, and an air gap is formed as a free space (or open space) confined between each of the steel plates and the outer layer of the housing cover. For example, the inner layers formed by the respective plates are distanced from (e.g., spaced from) the outer layer such that air gaps are formed as a free space confined between the respective plates and the outer layer. The plates may be, in one embodiment, steel plates. In such an embodiment, battery system may be provided with the double-layer structure including an air gap corresponding to some or all of the battery cells. Each of the battery cells may have its own plate, and thus, its own double-layer structure including an air gap. The plates may be welded to the outer layer of the housing cover. A known housing cover may be retrofitted with such plates, and thus, the coating on the outer surface of the outer layer of the housing cover may be protected from damage in the case of a thermal runaway event.

Embodiments of the present disclosure also pertain to an electric vehicle including a battery system as described above.

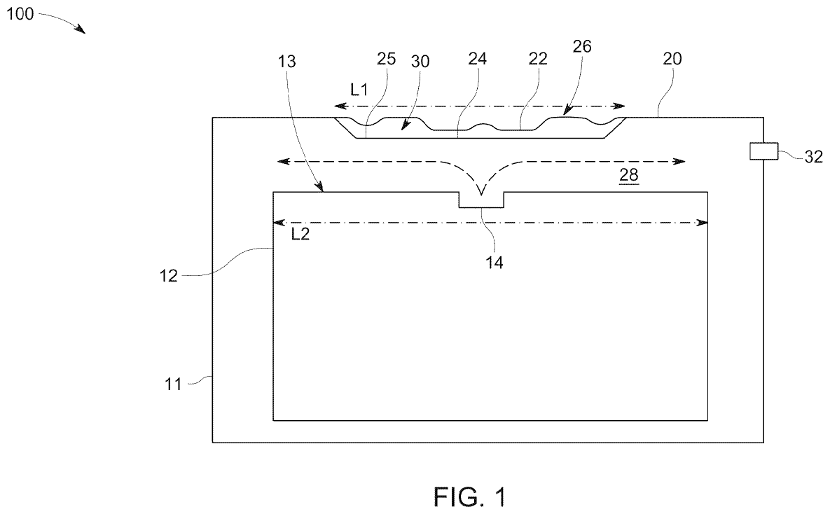

FIG. 1 shows a cross-section of a battery system 100 according to an embodiment of the present disclosure.

The battery system 100 includes a housing 11 and a plurality of battery cells 12 inside the housing 11, though only one battery cell 12 is shown in FIG. 1. The battery cell 12 has a venting side 13 with a venting exit 14 through which, during a thermal runaway event occurring inside the battery cell 12, a venting gas stream may exit the battery cell 12. A housing cover 20 covers the housing 11 to seal the battery system 100.

The housing cover 20 has a double-layer structure including (or formed by) an outer layer 22 and an inner layer 24. The outer layer 22 faces the outside of the battery system 100 and may prevent or reduce moisture and other contaminants from entering the battery system 100. The outer layer 22 may be coated with an anti-corrosion coating 26, for example, a zinc-nickel coating, to prevent or reduce corrosion of the outer layer 22 and, thus, the housing cover 20 due to contact with moisture.

The inner layer 24 may be a steel plate 25 that is attached, for example, welded, to the outer layer 22. In the following, the terms “inner layer” and “steel plate” are used interchangeably. The inner layer 24 of the housing cover 20 faces the venting side 13 of the battery cell 12 opposite the venting exit 14. The inner layer 24 and the outer layer 22 are distanced from (e.g., spaced from) each other such that an air gap 30 is formed as a free space confined between the inner layer 24 and the outer layer 22. Thus, by attaching the steel plate 25 to the outer layer 22 of the housing cover 20, the double-layer structure with the air gap 30 inside is provided opposite the venting exit 14. A venting channel 28 may be formed between the inner layer 24, that is, the steel plate 25, and the venting side 13 of the battery cell 12.

When a thermal runaway occurs inside the battery cell 12, a venting gas stream including hot venting gases and particles exits the battery cell 12 through the venting exit 14 into the venting channel 28. The venting gas stream flows towards the steel plate 25 and is deflected by the steel plate 25 to the sides, shown with dashed lines. The venting gas stream may exit the housing 11 through a housing venting valve 32. The venting gas stream thereby transfers heat to the steel plate 25, which forms the inner layer 24 of the double-layer structure of the housing cover 20. The air inside the air gap 30 acts as a thermal insulation preventing or at least significantly reducing heat transfer from the inner layer 24 to the outer layer 22. Thus, the outer layer 22 is protected from the venting gas stream at least while the venting gas stream is still hot. This prevents or reduces damage to the anti-corrosion coating 26 applied to the outer surface of the outer layer 22. Thus, the double-layer structure with the air gap therebetween improves (e.g., increases) the life expectancy of the battery system 100.

The air gap 30 and, therefore, the inner layer 24, does not need to extend along the entire length of the battery cell 12 but may extend (or may be provided) only near the venting exit 14 at where the temperature of the venting gas stream is the highest. After the venting gas stream is cooled down sufficiently by transferring heat at least to the steel plate 25, the venting gas stream may contact the outer layer 22 of the housing cover 20. Therefore, the air gap 30 may extend along a first length L1, which is less than a second length L2 along which the venting side 13 and, thus the battery cell 12 extends as shown in FIG. 1. This may allow for simpler construction.

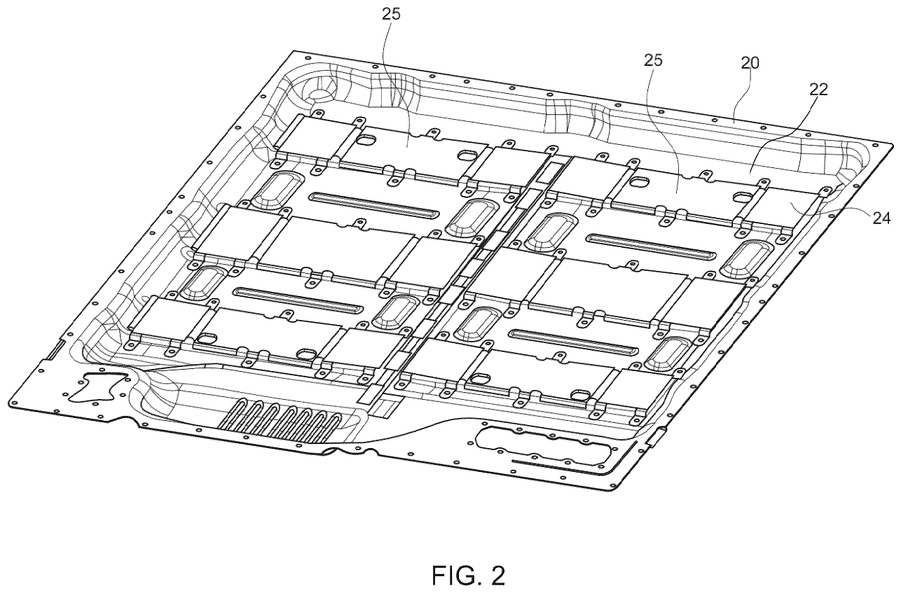

FIG. 2 shows the housing cover 20 shown in FIG. 1 from below. The housing cover 20 includes a plurality of steel plates 25 attached to the outer layer 22. For example, where the steel plates 25 are attached to the housing cover 20, the housing cover 20 is provided with an outer layer 22 and an inner layer 24, the inner layer 24 being made by (or formed by) the steel plates 25, respectively. Between each of the steel plates 25 and the outer layer 22 is a respective air gap 30 (see, e.g., FIG. 1). For example, multiple double-layer structures, each including an air gap between the two layers, are provided. When placed on top of a housing 11, as shown in FIG. 1, each of the steel plates 25 may cover one battery cell 12. Thus, each of the battery cells 12 may be provided with the double-layer structure including an air gap, with the inner layer 24 forming an upper wall of the respective venting channel 28. The anti-corrosion coating 26 applied to the outer layer 22 is, thus, sufficiently protected from the venting gas stream. The venting gas stream leaving a battery cell undergoing thermal runaway may then enter a common venting gas channel for (e.g., open to) all of the cells.

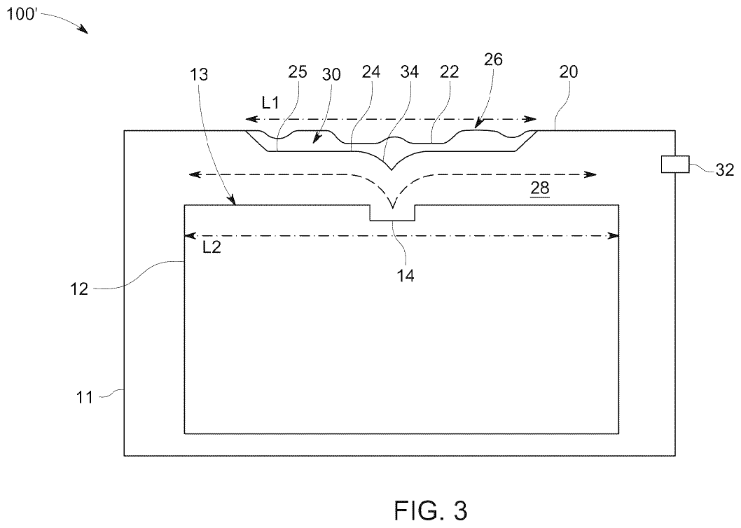

FIG. 3 shows a battery system 100′ according to another embodiment. The battery system 100′ differs from the battery system 100 described above in that the steel plate 25 and, thus, the inner layer 24 is provided with a guide projection 34. The guide projection 34 has a tapered shape with a tip facing the venting exit 14 and is configured to split (or separate) the venting gas stream such that the venting gas stream is deflected to opposite sides of the venting channel 28 as shown with dashed lines in FIG. 3. This improves heat transfer from the venting gas stream to the steel plate 25 and allows for improved transport of the venting gas stream away from the venting exit 14.

### SOME REFERENCE NUMERALS

11 housing
12 battery cell
13 venting side
14 venting exit
20 housing cover
22 outer layer of housing cover
24 inner layer of housing cover
25 steel plate
26 anti-corrosion coating
28 venting channel
30 air gap
32 housing venting valve
34 guide projection
100 battery system
100′ battery system

What is claimed is:

1. A battery system comprising:
a housing;
a battery cell accommodated within the housing, the battery cell having a venting side with a venting exit; and
a housing cover sealing the battery cell in the housing, the housing cover comprising an outer layer and an inner layer, the inner layer facing the venting side and forming part of a venting channel, the outer layer being coated on its outside surface with an anti-corrosion coating,
wherein the outer layer and the inner layer are spaced from each other such that an air gap is formed between the outer layer and the inner layer.

2. The battery system as claimed in claim 1, wherein the inner layer is a plate attached to an inside surface of the outer layer.

3. The battery system as claimed in claim 1, wherein the air gap extends along a first length, and the venting side extends along a second length, and
wherein the first length is smaller than the second length.

4. The battery system as claimed in claim 1, wherein the anti-corrosion coating is a zinc-nickel coating.

5. The battery system as claimed in claim 1, wherein both the outer layer and the inner layer comprise steel or a steel alloy.

6. The battery system as claimed in claim 1, wherein the inner layer comprises a guide projection protrusion protruding from the inner layer into the venting channel and towards the venting exit to guide the venting gas stream exhausted through the venting exit into the venting channel.

7. The battery system as claimed in claim 6, wherein the guide projection is a gas splitting projection having a tapered shape with a tip facing the venting exit and is configured to separate the venting gas stream such that the venting gas stream is deflected to opposite sides of the venting channel.

8. The battery system as claimed in claim 1, wherein the battery system further comprises a plurality of the battery cells arranged inside the housing,
wherein the housing cover comprises a plurality of steel plates attached to an inside surface of the outer layer of the housing cover, each of the steel plates facing the venting side of a respective one of the battery cells, and
wherein an air gap is formed as a free space confined between each of the steel plates and the outer layer of the housing cover.

9. An electric vehicle comprising the battery system as claimed in claim 1.
